(19) United States
(12) Patent Application Publication
(10) Pub. No.: US 2008/0152799 A1
(43) Pub. Date: Jun. 26, 2008

(54) Lens, coating apparatus for lens, and method for making the lens

(76) Inventor: Mei Li Jou, Yongkang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/642,514

(22) Filed: Dec. 21, 2006

(51) Int. Cl. B05D 5/06; G02C 7/02; B05C 13/02

(52) U.S. Cl. 427/164; 351/159; 118/503

(57) ABSTRACT

The present invention discloses a lens, a coating apparatus for the lens and manufacture method. A multilayer coating film of a uniform thickness is formed on the surface of the lens, and the lens is uniformly coated with a multilayer coating film. A coating apparatus for controlling the overall rotation is installed in the coating equipment for clamping and fixing a desired coating unit of the lens. The lens is rotated synchronously with the coating apparatus, such that when the coating equipment evaporates a thin film source layer by layer onto the rotating lens, the thin film source can be evaporated to every position of the surface of the lens thoroughly and uniformly, and thus a uniform thickness of the multilayer coating film can be maintained to provide consistent visual colors and effect to every position of the lens for providing a comfortable wear of the lens.

### FIELD OF THE INVENTION

The present invention relates to a lens, a lens coating apparatus, and a manufacture method of the lens, and more particularly to a lens having a multilayer coating film formed on the lens, and a desired coating unit installed on the lens for connecting a coating apparatus and a rotating base of a coating equipment, such that the rotating base can be rotated to drive the desired coating unit to rotate synchronously.

### BACKGROUND OF THE INVENTION

Referring to FIG. 1 for a color film coated on a conventional lens, the color film is usually coated onto the surface of the lens, such that the thickness of the color film situated at the front edge is not equal to the thickness of the color film situated at the rear edge, and thus the conventional coated lens will give different visual colors and effects, and the vision from an internal side of a traditional lens is uneven which will adversely affect the comfort and vision of our eyes.

In the manufacturing process of traditional lenses, a lens is clamped and fixed directly by a coating apparatus in the coating equipment. Although the coating apparatus is aligned with the an outlet of a thin film source, the direction for clamping the lens is fixed, so that when the thin film source flows out towards the coating apparatus in the same direction with the outlet, the thin film source will be centralized at the same position of the coating apparatus. Since the lens for glasses is in a curved shape, a thin film source can be attached more easily onto the protruding front edge on the front side of the lens than both lateral sides of the front edge of the lens, and thus the thin film source cannot be coated uniformly onto a desired position at the surface of the lens and the thickness of a color film of the thin film source becomes uniform. For example, the thickness of the color film on both sides (left and right sides) is smaller than the thickness of the color film at the front side, and the visual color and effect on both lateral sides are not as good as the visual color and effect at the front side. For an overall lens, the front edge of the front has a color difference with the lateral sides of the front visually, and the whole lens cannot achieve the expected color effect. If a color film of a lens has a different thickness and a different visual color or effect, the visual effects at different positions of the lens are inconsistent while a user is wearing the lens, or even causes discomforts or damages to the user's eyes. Such lens cannot be worn after being used for a period of time.

In view of the foregoing shortcomings, the present invention provides a lens coated uniformly with a multilayer coating film of a specific thickness to effectively overcome the shortcomings of the conventional lens and enhance the effect of wearing the lens.

### SUMMARY OF THE INVENTION

The primary objective of the present invention is to provide a lens, a coating apparatus for the lens and a manufacture method. A multilayer coating film of a uniform thickness is formed on the surface of the lens, and the lens is uniformly coated with a multilayer coating film. A coating apparatus for controlling the overall rotation is installed in the coating equipment for clamping and fixing a desired coating unit of the lens. The lens is rotated synchronously with the coating apparatus, such that when the coating equipment evaporates a thin film source layer by layer onto the rotating lens, the thin film source can be evaporated to every position of the surface of the lens thoroughly and uniformly, and thus a uniform thickness of the multilayer coating film can be maintained to provide consistent visual colors and effect to every position of the lens for providing a comfortable wear of the lens.

To achieve the foregoing objective, the present invention provides a lens, and the front side of the lens has a multilayer coating film, and the multilayer coating film has a specific thickness and is uniformly coated onto the surface of the lens for providing a consistent visual color effect for every position on the surface of the lens to achieve a comfortable wear of the lens.

To achieve the foregoing objective, the present invention provides a coating apparatus for the lens connected to a rotating base in a coating equipment, such that the rotating base is rotated circumferentially around an axis to drive the coating apparatus to rotate accordingly, and the coating apparatus comprises a base disc fixed with the rotating base for rotating the base disc with the rotating base, and the base disc includes a pivotal leaning portion; a plurality of support frames fixed to the base disc, and another end is fixed to the positioning base to form an engaging end, and the engaging end has a pivotal connection portion; a positioning base integrated with the base disc by the support frame, and an axle base is movably and pivotally coupled at the middle position of the positioning base, and another end of the axle base is fixed with the coating equipment and maintained still, and an external side of the axle base has as gear disc; a plurality of desired coating units, having a main body for installing the lens, and the main body has a circular portion disposed at an end corresponding to the pivotal leaning portion of the base disc, and a gear portion and a circular portion disposed at another end corresponding to the circular portion, and the gear portion is engaged with the gear disc of the axle base and rotated circumferentially around the gear disc of the axle base; the main body has a plurality of rows of clamping elements, and both ends of each clamping element have an elastic clamping portion, for adjusting the elastic clamp according to the width of the lens and positioning the lens stably.

To achieve the foregoing objective, the present invention provides a manufacture method for coating a lens that clamps the lens by a clamping element of a desired coating equipment, such that the coating apparatus is installed with many lenses, and the coating apparatus with many lenses is connected and positioned with the rotating base by the base disc. After the coating equipment starts operating, the rotating base is driven by an internal motive power to rotate circumferentially and drive the coating apparatus to rotate accordingly. If the coating apparatus is rotated, the coating unit will be rotated synchronously, since the desired coating unit is movably connected with a pivotal leaning portion of a circular portion corresponding to another end of the base disc. If the desired coating unit is rotated synchronously, a gear portion at an end of the desired coating unit is rotated around a gear of the fixing axle base, such that the coating apparatus and the desired coating unit can be rotated independently and successfully. As a result, the lens clamped and fixed on the main body of the coating unit produces a multiple of rotations, and the coating equipment coats a single layer or a multilayer film of the thin film source by the corresponding coating apparatus, and thus every position on the surface of the lens can be coated thoroughly and uniformly, and a multilayer coating film with an even thickness can be formed on the surface of the lens.

### BRIEF DESCRIPTION OF THE DRAWINGS

FIG. 1 is a schematic view of a conventional lens with an uncut and untrimmed coating film;

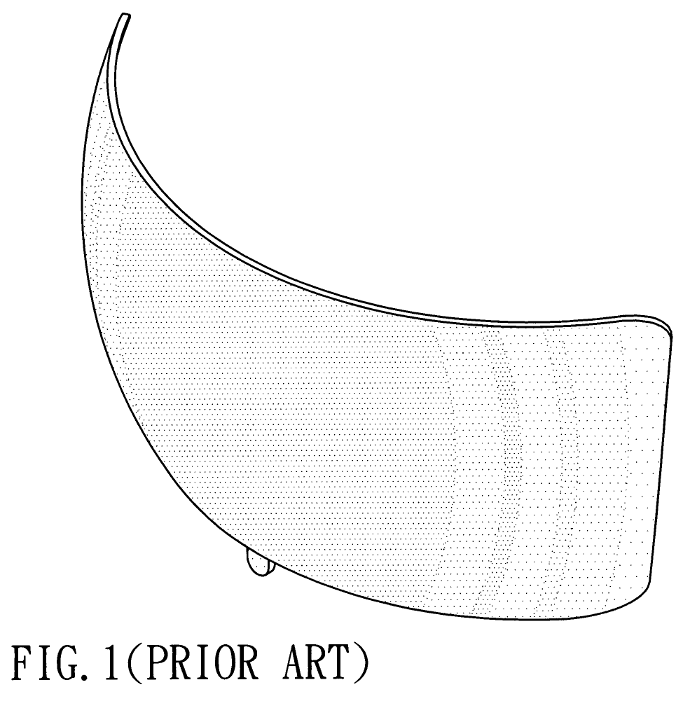

FIG. 2 is a schematic view of a conventional lens with a cut and trimmed coating film;

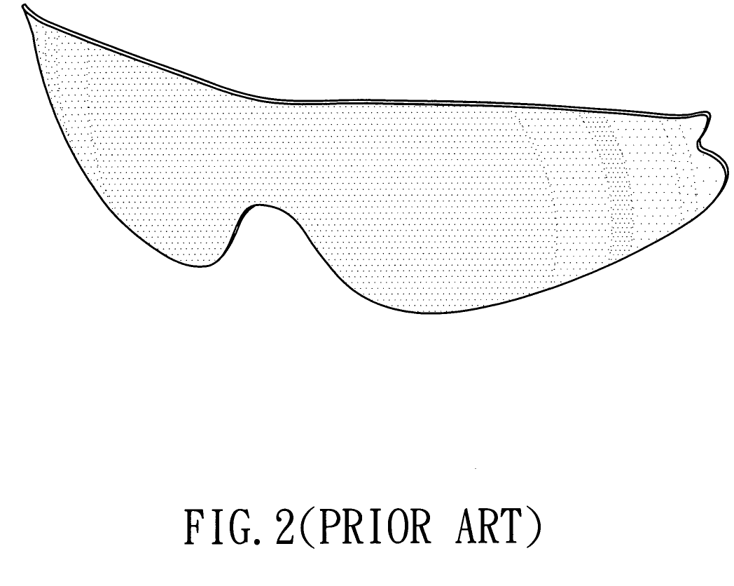

FIG. 3 is a perspective view of a lens with an uncut and untrimmed coating film in accordance with the present invention;

FIG. 4 is a perspective view of a cut and trimmed lens in accordance with the present invention;

FIG. 5 is a schematic view a lens applied in glasses in accordance with a preferred embodiment of the present invention;

FIG. 6 is a perspective view of an uncoated lens of the present invention;

FIG. 7 is a schematic view of a coating apparatus of the present invention;

FIG. 8 is a first schematic enlarged view of a coating apparatus of the present invention;

FIG. 9 is a second schematic enlarged view of a coating apparatus of the present invention;

FIG. 10 is a third schematic enlarged view of a coating apparatus of the present invention;

FIG. 11 is a bottom view of a structure of a coating apparatus of the present invention; and

FIG. 12 is a flow chart of coating a lens in accordance with the present invention.

### DETAILED DESCRIPTION OF THE PREFERRED EMBODIMENTS

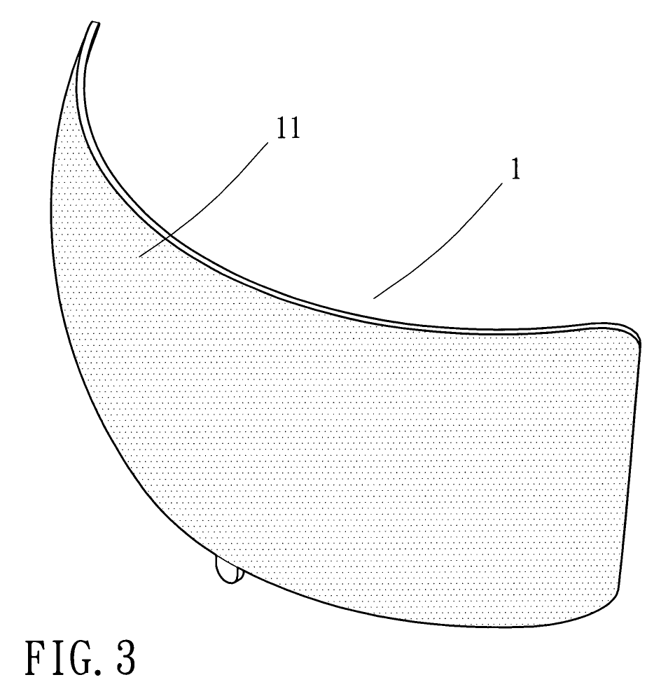

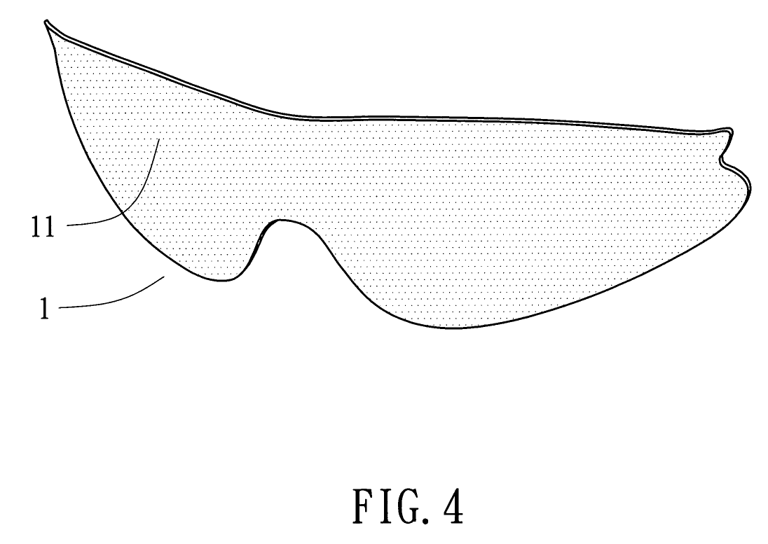

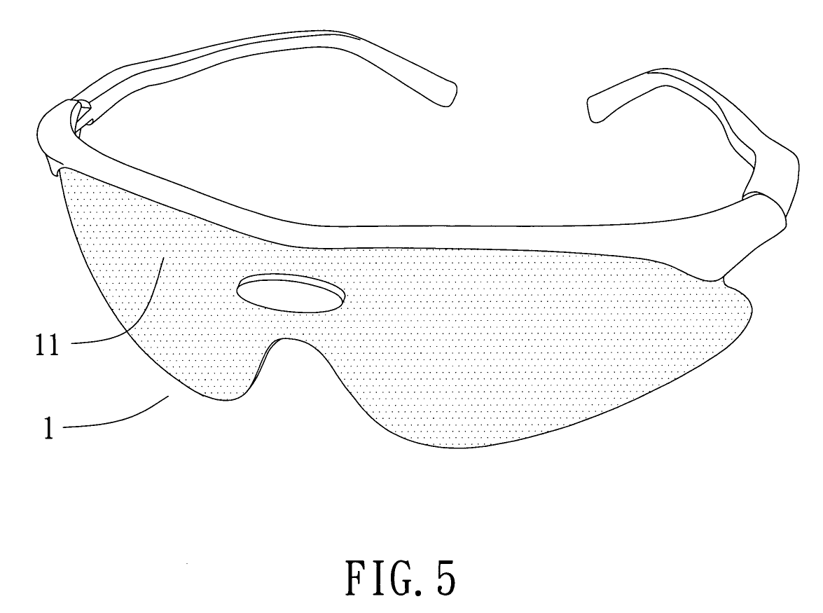

Referring to FIGS. 3 to 5 for perspective views of an uncut and untrimmed lens, a cut and trimmed lens, and a lens used for glasses in accordance with the present invention respectively, a first key point of the invention resides on that a multilayer coating film 11 is formed on a lens 1 (including a curved lens) and comes with a specific thickness and is coated uniformly on the surface of the lens 1 for providing consistent visual colors and effects for every position on the surface of the lens 1 to provide a comfortable wear when the lens is applied to glasses (as shown in FIG. 5).

The foregoing multilayer coating film 11 can be evaporated alternatively by silicon dioxide (SiO₂) and titanium dioxide (TiO₂) layer by layer onto the surface of the lens 1.

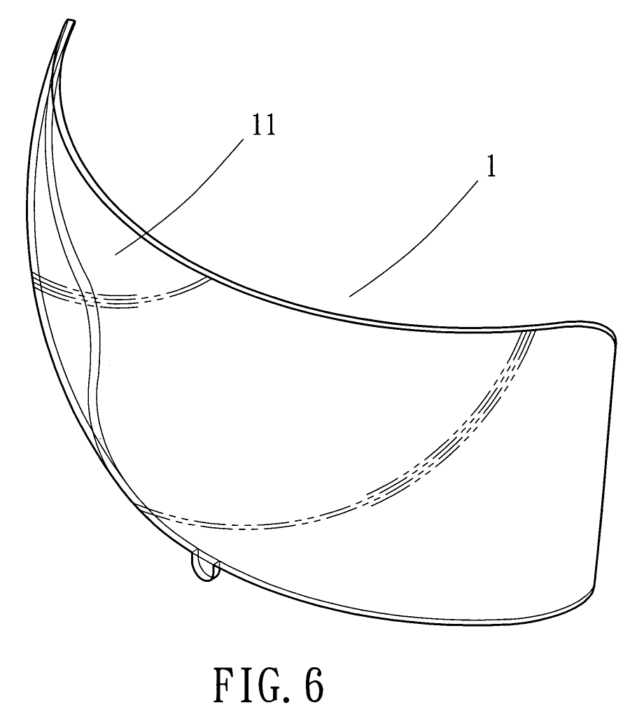

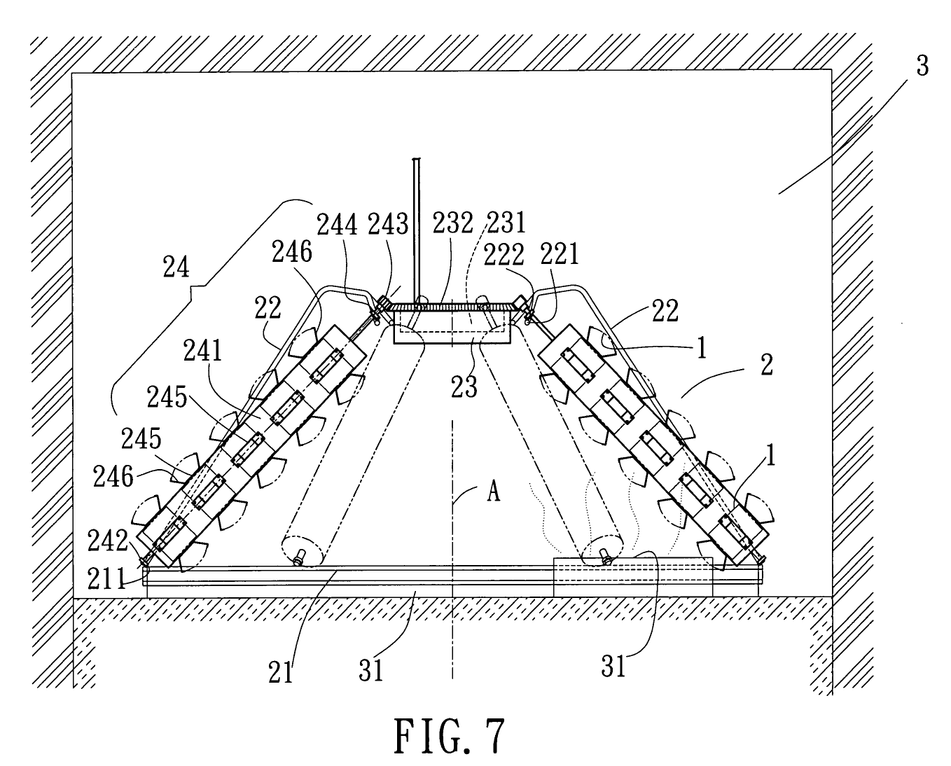

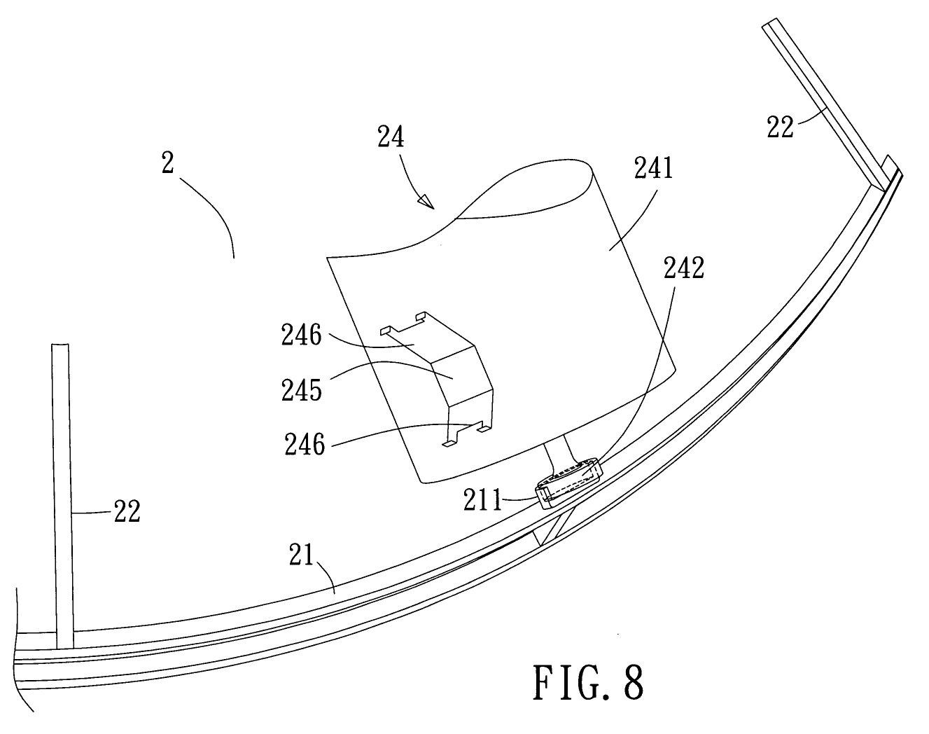

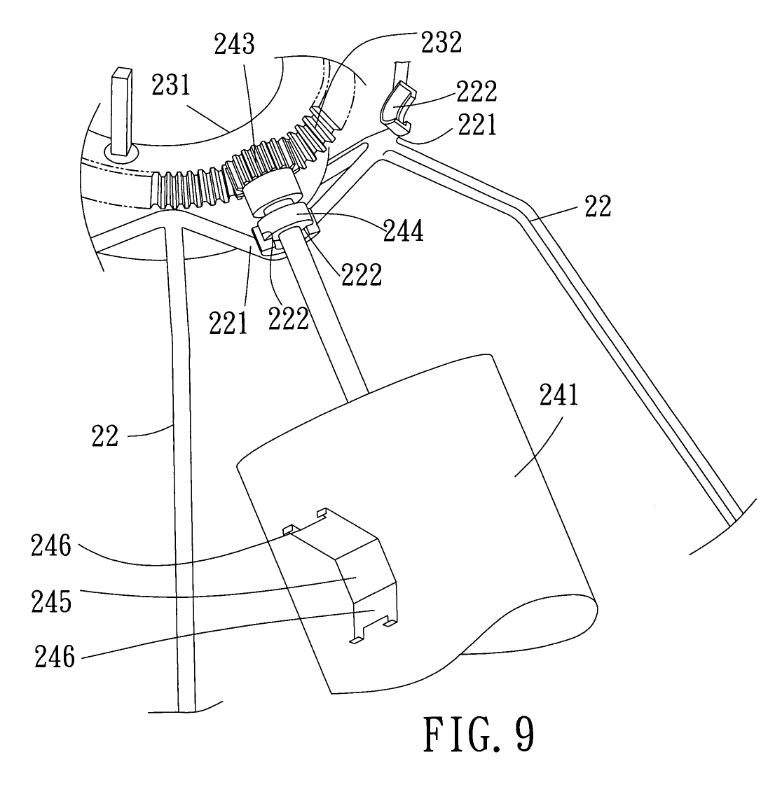

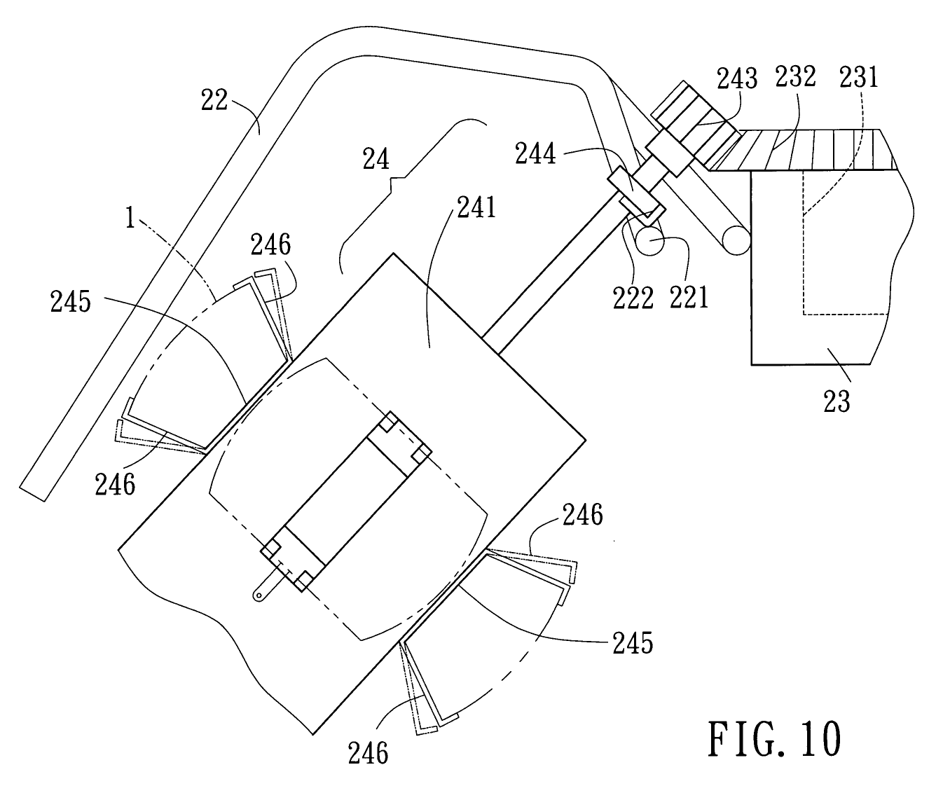

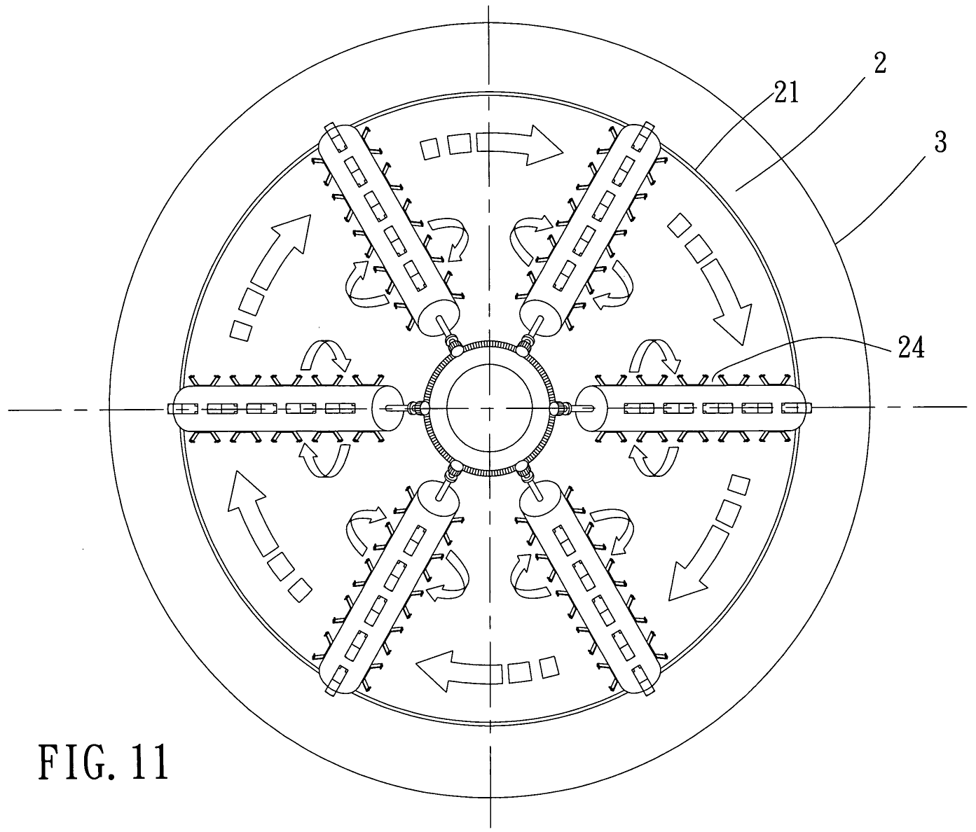

Referring to FIGS. 6 to 11 for a perspective view of an uncoated lens, a schematic view of a coating apparatus, a coating apparatus combined with a coating equipment, and first, second and third enlarged views of a coating apparatus, and a bottom view of a coating apparatus in accordance with the present invention, a second key point of the present invention resides on that a coating apparatus 2 disposed in a coating equipment for positioning a lens 1 is connected to a rotating base 31 having a motive power source in the coating equipment 3, such that the rotating base 31 can produce a circumferential rotation around a central axis A to drive the coating apparatus 3 to rotate together.

The coating apparatus 2 comprises:

a base disc 21, coupled and positioned with a rotating base 31 of the coating equipment 3, for rotating the base disc 21 with the rotation of the rotating base 31, and the base disc 21 has protruding semicircular pivotal leaning portion 211;

a plurality of support frame 22, fixed to the base disc 21, and another end corresponding to the base disc 21 having a positioning base 23 to form an engaging end 221, and the engaging end 221 having a pivotal connection portion 222;

a positioning base 23, integrated with the base disc 21 by a support frame 22 with a section apart, and having a fixing axle base 231 movably and pivotally connected to the middle of the positioning base 23, and another end of the fixing axle base 231 being fixed with the coating equipment 3 and remaining still, and an external side of the fixing axle base 231 having a gear disc 232; and

a plurality of desired coating units 24, having a main body 241 for installing the lens 1, a circular portion 242 disposed at an end of the main body 241 corresponding to the pivotal leaning portion 211 of the base disc 21, and a gear portion 243 and a circular portion 244 disposed sequentially at another end corresponding to the circular portion 242, and the gear portion 243 being engaged with a gear disc 232 of the fixing axle base 231, and provided for a gear disc 231a to rotate circumferentially around the fixing axle base 231; and the main body 241 further having a plurality of rows of clamping elements 245, and both ends of the clamping element 245 separately having an elastic clamping portion 246 that can be flexibly adjusted up and down, for adjusting the width for clamping the lens 1 and stably positioning the lens 1.

Therefore, the lens 1 can be positioned by the plurality of desired coating units 24 through the elastic clamping portion 246 of the main body 241, and both ends of the circular portion 242, 244 and the gear portion 243 are connected separately to the pivotal leaning portion 211 of the base disc 21 and the pivotal connection portion 222 of the support frame 22 and engaged with the gear disc 232 of the fixing axle base 231, such that the plurality of desired coating units 24 can be movably installed between the base disc 21 and the positioning base 23. With the link of the rotating base 31, the whole coating apparatus 3 can be rotated, and the desired coating unit 24 also rotates with the coating apparatus 3, such that the lens can produce a multiple of rotations in the coating apparatus 3 to uniformly spread the thin film source onto each position of the lens 1 and form the required multilayer coating film, and thus the lens 1 has a uniform multilayer coating film with a certain specific thickness.

Further, the coating equipment of the present invention is the equipment primarily used for evaporations, and an outlet 32 of the thin film source proximate to the bottom of the rotating base 31 is provided for flowing the thin film source out upward (in the direction towards the coating apparatus).

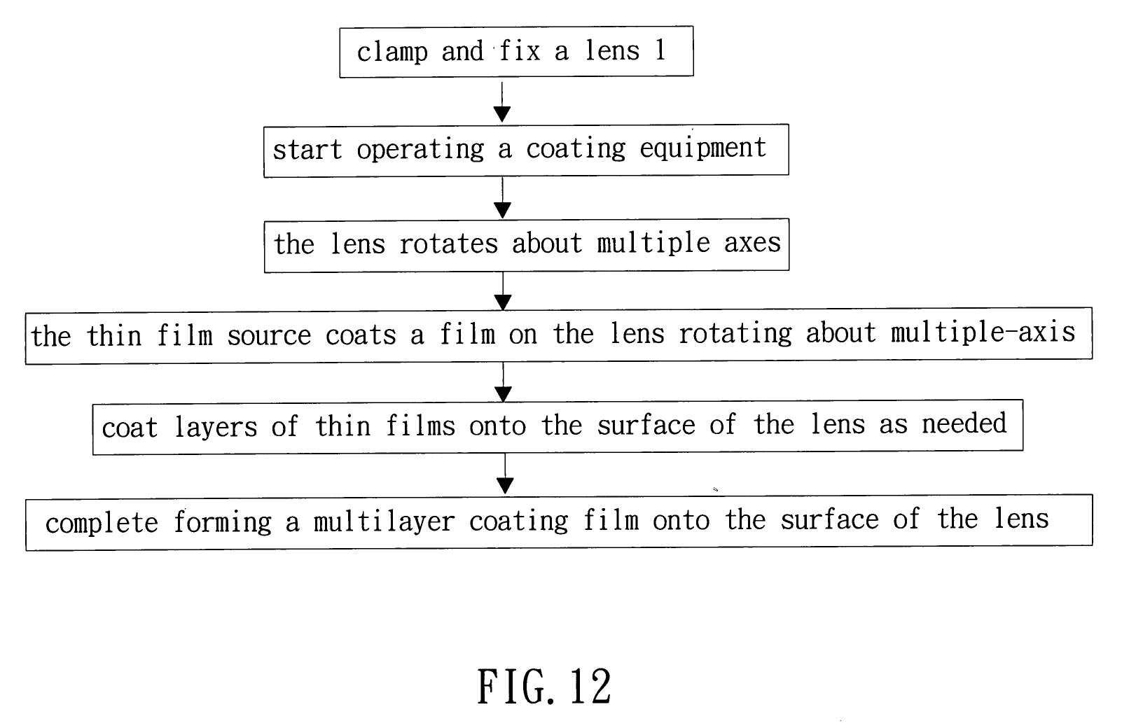

Referring to FIG. 12 for a flow chart of a manufacture method for coating a film, the third key point of the present invention resides on that the lens 1 is clamped on the coating apparatus 2, and the coating apparatus 2 is positioned and fixed in the coating equipment 3, and the coating equipment 3 controls the coating apparatus 2 to produce a multiple of rotations.

The method of coating a multilayer coating film onto the surface of the lens 1 comprises the following steps:

1. Clamp and fix a lens 1: Clamp and fix the lenses with a desired film one by one on the main body 241 through a coating apparatus 2 by an elastic clamping portion 246 of a clamping element 245;

2. Start operating a coating equipment: The rotating base 31 is rotated around a central axis A, such that the coating apparatus 2 is rotated accordingly and the required thin film source is produced;

3. Produce a multiple-axis rotation for the lens 1: The lens 1 rotates with the coating apparatus 2 and the desired coating unit 24 also rotates synchronously to produce a multiple-axis rotation for attaching the thin film source onto the lens 1 successfully;

4. Perform an overall coating of thin film source onto the lens with a multiple of rotations: The outlet 32 disposed at the bottom of the rotating base 31 of the coating equipment is used for flowing the thin film source upward (in the direction towards the coating apparatus 2) to perform an overall coating of thin film source onto the lens with a multiple of rotations;

5 Attach layers of thin films onto the surface of the lens according to the required number of times of the coatings; and

6. Complete forming a multilayer coating film onto the surface of the lens 1.

In summation of the description above, the thin film source can be evaporated onto the entire surface of the lens 1 thoroughly and uniformly to produce a uniform multilayer coating film 11 with a certain specific thickness during the process providing a multiple of rotations for the lens clamped and fixed by the coating apparatus 2, such that the thickness on every position of the surface of the lens 1 is consistent. Similarly, the visual color and effect produced by the surface of the lens 1 can be consistent for preventing users to see their own eyes from another surface (rear lateral surface) of the lens 1 or any uneven vision at different positions. In the meantime, the dual features of silicon dioxide (SiO₂) and titanium dioxide (TiO₂) is used, not only providing a clear, consistent and comfortable effect for wearing a lens with a multilayer coating film 11 and viewing from different positions of the lens, but also effectively achieving the eye protection effect, and extending the wearing time of glasses.

While the invention has been described by means of specific embodiments, numerous modifications and variations could be made thereto by those skilled in the art without departing from the scope and spirit of the invention set forth in the claims.

What is claimed is:

1. A lens comprising:
a multilayer coating film formed on said lens, and said multilayer coating film having a thickness and being coated uniformly on a surface of said lens.

2. A coating apparatus of lens, wherein the coating apparatus is installed in a coating equipment to which a lens is fixed, and connected to a rotating base of said coating equipment with a motive power source, when said rotating base is rotated to drive said coating apparatus to rotate and coat a film onto a surface of said lens by a film source of said coating equipment, said coating apparatus comprises a base disc, a plurality of support frames, a positioning base and a plurality of coating units, said base disc is fixed to a rotating base of said coating equipment so as to rotate said base disc with said rotating base, said base disc includes a protruding semicircular pivotal portion, said plurality of support frames are installed at said base disc and another end corresponding to said base disc is fixed to said positioning base to form an engaging end, said engaging end includes a pivotal connection portion, said positioning base is separated with said base disc with a section for integrating said support frame as a whole, a fixing axle base is movably and pivotally coupled to the middle position of said positioning base, another end of said fixing axle base is fixed with said coating equipment and remained still, an external side of said fixing axle base includes a gear disc, a plurality of coating units have a main body for installing a plurality of lens, said main body has a circular portion disposed on said main body, said main body has a gear portion and a circular portion disposed sequentially corresponding to an end of said pivotal leaning portion of said base disc and another end corresponding to said circular portion, a gear portion is engaged with a gear disc of said fixing axle base and rotated circumferentially around said gear disc of said fixing axle base.

3. The coating apparatus for lens as claimed in claim 2, wherein said main body includes a plurality of rows of clamping elements and both sides of each of the clamping elements has an elastic clamping portion that is adjusted up and down for adjusting a clamp to the lens according to a width of the lens and securely positioning said lens.

4. A film coating manufacture method, wherein the lens is clamped on a coating apparatus and positioned in a coating equipment, controlling said coating apparatus by said coating equipment to rotate and coat a multilayer coating film onto the surface of said lens by a procedure comprising the steps of:
clamping and positioning said lens: using said coating apparatus to clamp and position said lens to be coated one by one on a main body of a coating unit;
activating said coating equipment to rotate a rotating base and said coating apparatus being rotated with the rotating base to produce a film source;
driving said lens to rotate in different axes: said lens rotates with said coating apparatus and said coating unit also rotates synchronously to generate rotations about different axes;
coating every position of a rotating lens by said film source;
attaching said film source one by one onto the surface of said lens to required number of coating films, and
forming a multilayer coating film with a specific thickness uniformly on every position of the surface of said lens.

5. The lens as claimed in claim 1, wherein said multilayer coating films are evaporated by silicon dioxide (SiO₂) and titanium dioxide (TiO₂) layer by layer onto the surface of said lens.

6. The film coating manufacture method for lens as claimed in claim 4, wherein said multilayer coating films are evaporated by silicon dioxide (SiO₂) and titanium dioxide (TiO₂) alternatively layer by layer onto the surface of said lens.
